(19) United States
(12) Patent Application Publication
(10) Pub. No.: US 2006/0104483 A1
(43) Pub. Date: May 18, 2006

(54) Wireless digital image capture device with biometric readers

(75) Inventors: Dan Harel, Rochester, NY (US); John C. Neel, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/987,849

(22) Filed: Nov. 12, 2004

(51) Int. Cl. G06K 9/00

(52) U.S. Cl. 382/115; 340/5.82

(57) ABSTRACT

A digital image capture device and method for operating the same are provided. The digital image capture device has a digital image capture device comprising: a housing (20); a digital image capture system (22); a biometric reader (70) adapted to sense biometric data of a user; a wireless communication circuit (54) adapted to transmit wireless signals to a remote database and to receive authorization signals from the remote database; a processor (26) adapted to control and enable operation of the digital image capture system (22), the wireless communication circuit (54) and the biometric reader (70), wherein the processor (26): is adapted to cause biometric data to be read from a user, and wirelessly transmitted to a remote database so that the remote database can compare the sensed biometric data to stored biometric data and will transmit an authorization signal when the sensed biometric data corresponds to stored biometric data, said processor further being adapted to determine a set of authorized actions for a user of the digital image capture device based upon an authorization signal transmitted by the remote database; with said processor further being adapted to execute actions as requested by the user when the requested actions are within the set of authorized actions.

### FIELD OF THE INVENTION

The present embodiments relate to digital image capture devices and methods adapted to provide control of the devices.

### BACKGROUND OF THE INVENTION

A digital camera, whether still or motion video, typically contains an on-board processor that can be programmed to perform a variety of functions. Among other things, the processor can be programmed to embed metadata information, such as a photographer's name in a captured image. The processor can be connected to on board additional features, such as a flash for artificial lighting. The processor can connect to biometric readers, such as retinal scanners, to lock or unlock a digital camera based on biometric data stored in the digital image capture device.

Such biometric data, and the programming necessary to compare such biometric data to measured biometric data, typically requires a large amount of memory which makes such digital image capture devices expensive.

The memory consumption problem becomes particularly acute where multiple people are to be authorized to use a single digital image capture device. Further, there is a significant privacy risk involved in storing biometric data for one or more people in a portable device that can be lost of stolen. This is because knowledgeable thieves can extract such information and put it to improper use.

Accordingly, a need exists in the art for a digital image capture device that can use biometric data for authorization purposes, control purposes, authentication purpose, and other purposes without exposing such biometric data to the risk described above.

### SUMMARY OF THE INVENTION

In one aspect of the invention, a digital image capture device is provided. The digital image capture device has: a housing, a digital image capture system, a biometric reader adapted to sense biometric data of a user, and a wireless communication circuit adapted to transmit wireless signals to a remote database and to receive authorization signals from the remote database. A processor is adapted to control and enable operation of the digital image capture system, the wireless communication circuit, and the biometric reader. Wherein the processor is adapted to cause biometric data to be read from a user and wirelessly transmitted to a remote database so that the remote database can compare the sensed biometric data to stored biometric data and transmit an authorization signal when the sensed biometric data corresponds to the stored biometric data, the processor further being adapted to determine a set of authorized actions for a user of the digital image capture device based upon the authorization signal transmitted; with the processor further being adapted to execute actions as requested by the user when the requested actions are within the set of authorized actions.

In another aspect of the invention, a method for operating a digital image capture device is provided. In accordance with the method, biometric data from at least one user is obtained and the biometric data is stored in a database. Biometric data from a user of the device is read and the biometric data is transmitted to the database wirelessly. A set of authorized actions is determined based upon the biometric data, and the digital image capture device is wirelessly enabled to perform the set of authorized actions.

It will be appreciated that in various embodiments of the invention digital imaging devices can be activated and deactivated based on the biometric data obtained locally, and compared to biometric data for the user that is stored remotely. In this way, control over the digital imaging device can be determined based upon sensed biometric data without the need to store comparative biometric data in the digital imaging device.

### BRIEF DESCRIPTION OF THE DRAWINGS

In the detailed description of the preferred embodiments presented below, reference is made to the accompanying drawings, in which:

FIG. 1 depicts a block diagram of one embodiment of an imaging system;

FIG. 2 depicts a top, back, and right side perspective view of one embodiment of an imaging system;

FIG. 3 depicts a perspective view of an embodiment of the digital image capture device usable in the wireless mode; and

FIG. 4 depicts a perspective of an embodiment of the digital image capture device that is in the form of a pair of eyeglasses and usable in the wireless mode.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways including the use of multiple methods of identification on any single digital image capture device for added security, such as eye detection and voice detection.

Various embodiments relate to digital cameras or digital image devices, such as cellular phones, that utilize biometric data and then convert the biometric data into a metadata file that can be used to lock or enable the device wirelessly.

Certain embodiments, allow professional photographers to accurately authenticate the photographer who captures an image so that the contractual, licensing, and moral rights associated with a captured image can be protected. On the consumer level, this embodiment enables a viewer to identify who took an image years from the date when the image was taken. This embodiment adds value to the experience of image sharing.

The input of the wireless data provides a faster and more efficient tracking system compared to inputting simply basic time and date information from the camera. The real time connect and enablement features and the wireless transmission features enable news photographers covering an important event to track all the images effectively, in real time.

As will be described in greater detail below, such biometric data can be acquired from methods such as fingerprint recognition readers, voice print recognition devices, or retinal image recognition scanners.

Attaching biometric data of the user to an image captured by that user can be useful in a setting were more than one photographer is using photography equipment and real time transmission, or instant subsequent transmission is needed. The use of biometric data and the wireless connection provides for real time tracking of devices that can be used as a theft deterrent. Additionally, if a camera, such as an expensive piece of television camera equipment is stolen, the biometric reader is remotely activated. If the unauthorized party uses the camera, the biometric data can be transmitted to the police to aid in apprehending unauthorized party and finding the digital image capture device for example using a global positioning system (GPS). The wireless tracking and enablement of a device having a biometric reader provides an unexpected and significant benefit in aiding the police in finding and identifying criminals with certainty.

For example, if a person walks into a dark parking lot at night wearing a digital capture device and an intruder approaches, a picture of the intruder can be taken, and then transmitted with all the accompanying metadata to a remote secure location, such as a police station. The police, having the identity and location of the intruder, would then act to prevent a potential crime.

The biometric information that is read by the digital image capture device about the user is wirelessly transmitted to a central database and can also be applied directly to a digital image captured by the user.

The digital image capture device with biometric reader provides the ability to trace all digital images all the way back to the original photographer and the original image. This advantageous aspect is useful if a photo is modified or used in conjunction with other photos and when tracing of the original photographer is lost. The original author of the photo can be readily identified. This embodiment enables permission to be obtained more easily from the original photographer to use the image.

Biometric authentication provides a theft deterrent or use control of the image capture device since the image capture device can be programmed to be turned on or take a image based on a signal from a remote device connected wirelessly to the digital image capture device. For example, users can rent an image capture device to use in a particular location, such as a sports event, wherein the image capture device is programmed to only work in the particular location based on a wireless signal. The image capture device can include a location device so any theft attempt would reveal the thief's identity and location and prevent him or her from using the camera outside the zone of the signal.

Additional embodiments contemplate a method to customize individual digital image capture devices that have multiple users, such as an image capture device owned by a design firm for the use of ten employees. In this embodiment, each user enters a preference into a database for the camera or image capture device. When the device identifies the user, the device wirelessly signals the main database with the biometric data to retrieve that user's preferences and sets the digital image capture device to those preferences. The database with the user preferences can either be a remote database or a database that is incorporated into the device.

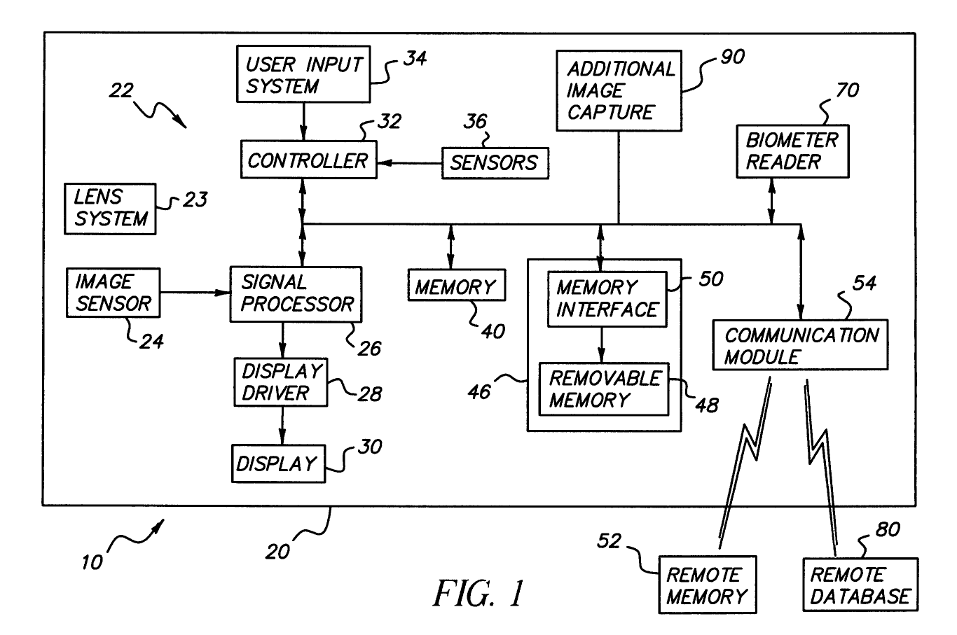

With reference to the figures, FIG. 1 depicts an embodiment of a digital image capture device 10.

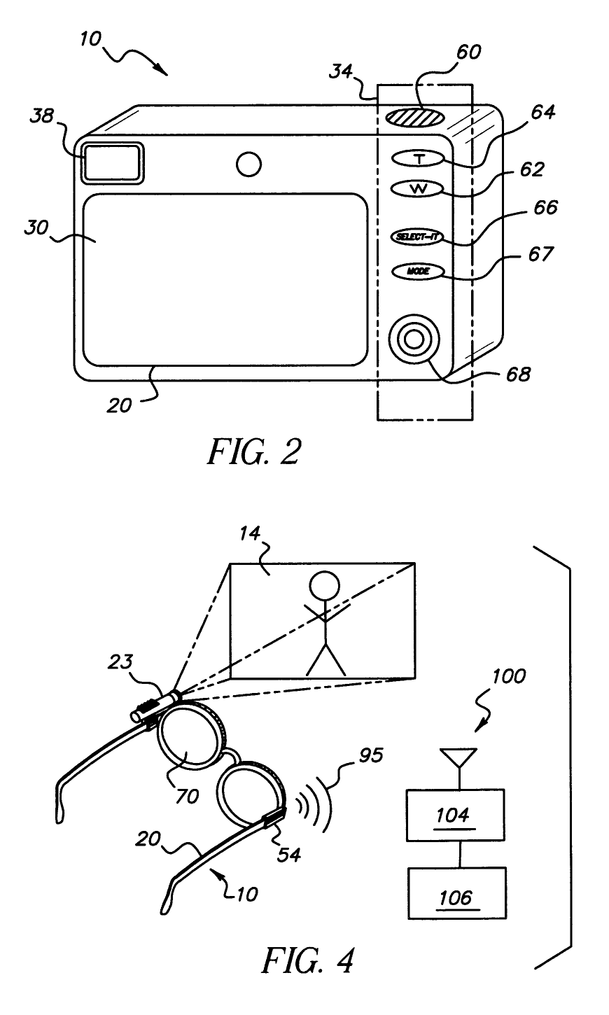

FIG. 1 shows a block diagram of one embodiment of an digital image capture device 10. FIG. 2 shows a top, back, right side perspective view of the digital image capture device 10 of FIG. 1. As is shown in FIG. 1 and FIG. 2, digital image capture device 10 comprises a body 20 containing an image capture system 22 having a lens system 23, an image sensor 24, a signal processor 26, an optional display driver 28 and a display 30.

In the embodiment shown in FIGS. 1 and 2, body 20 has a generally conventional camera shape. However, in other embodiments, body 20 can take on a variety of other shapes including wearable shapes, such as a brooch or glasses. In operation, light from a scene is focused by lens system 23 to form an image on image sensor 24. Lens system 23 can have one or more elements. Lens system 23 can be of a fixed focus type or can be manually or automatically adjustable. Lens system 23 is optionally adjustable to provide a variable zoom that can be varied manually or automatically. Other known arrangements can be used for lens system 23.

Light from the scene that is focused by lens system 23 onto image sensor 24 is converted into image signals representing an image of the scene. Image sensor 24 can comprise a charge couple device (CCD), a complimentary metal oxide sensor (CMOS), or any other electronic image sensor known to those of ordinary skill in the art. Image signals can be in digital or analog form.

Signal processor 26 receives image signals from image sensor 24 and transforms the image signal into a digital image in the form of digital data. The digital image can comprise one or more still images, multiple still images and/or a stream of apparently moving images such as a video segment. Where the digital image data comprises a stream of apparently moving images, the digital image data can comprise image data stored in an interleaved or interlaced image form, a sequence of still images, and/or other forms known to those of skill in the art of digital video.

Signal processor 26 can apply various image processing algorithms to the image signals when forming a digital image. These can include but are not limited to color and exposure balancing, interpolation and compression. Where the image signals are in the form of analog signals, signal processor 26 also converts these analog signals into a digital form.

A controller 32 controls the operation the digital image capture device 10, including but not limited to image capture system 22, display 30 and memory such as memory 40 during imaging operations. Controller 32 causes image sensor 24, signal processor 26, display 30 and memory 40 to capture, store and display images in response to signals received from a user input system 34, data from signal processor 26 and data received from optional sensors 36. Controller 32 can comprise a microprocessor such as a programmable general purpose microprocessor, a dedicated microprocessor or micro-controller, or any other system that can be used to control operation of digital image capture device 10.

Controller 32 cooperates with a user input system 34 to allow imaging device 10 to interact with a user. User input system 34 can comprise any form of transducer or other device capable of receiving an input from a user and converting this input into a form that can be used by controller 32 in operating digital image capture device 10. For example, user input system 34 can comprise a touch screen input, a touch pad input, a 4-way switch, a 6-way switch, an 8-way switch, a stylus system, a trackball system, a joystick system, a voice recognition system, a gesture recognition system or other such systems. In the embodiment shown in FIG. 1 and FIG. 2 user input system 34 includes a shutter trigger button 60 that sends a trigger signal to controller 32 indicating a desire to capture an image.

In the embodiment of digital image capture device 10 shown in FIG. 1 and FIG. 2, user input system 34 also includes a wide-angle zoom button 62, and a tele zoom button 64 that cooperate with controller 32 to control the zoom settings of lens system 23 causing lens system 23 to zoom out when wide angle zoom button 62 is depressed and to zoom out when tele zoom button 64 is depressed. Wide-angle zoom lens button 62 and telephoto zoom button 64 can also be used to provide signals that cause signal processor 26 to process image signal so that the digital image formed thereby appears to have been captured at a different zoom setting than that actually provided by the optical lens system. This can be done by using a subset of the image signal and interpolating a subset of the image signal to form the digital image. User input system 34 can also include other buttons including joystick 68 shown in FIG. 2, the mode selector button 67 and select-it button 66 shown in FIG. 2, the function of which will be described in greater detail below.

Sensors 36 are optional and can include light sensors, range finders and other sensors known in the art that can be used to detect conditions in the environment surrounding digital image capture device 10 and to convert this information into a form that can be used by controller 32 in governing operation of digital image capture device 10. Sensors 36 can also include sonic, touch, ultrasonic, light and/or other sensors.

Controller 32 causes an image signal and corresponding digital image to be formed when a trigger condition is detected. Typically, the trigger condition occurs when a user depresses shutter trigger button 60, however, controller 32 can determine that a trigger condition exists at a particular time, or at a particular time after shutter trigger button 60 is depressed. Alternatively, controller 32 can determine that a trigger condition exists when optional sensors 36 detect certain environmental conditions.

Controller 32 can also be used to generate metadata M in association with each image. Metadata is data that is related to a digital image or a portion of a digital image but that is not necessarily observable in the image data itself. In this regard, controller 32 can receive signals from signal processor 26, camera user input system 34 and other sensors 36 and, optionally, generates metadata based upon such signals. The metadata can include but is not limited to information such as the time, date and location that the archival image was captured, the type of image sensor 24, mode setting information, integration time information, taking lens unit setting information that characterizes the process used to capture the archival image and processes, methods and algorithms used by digital image capture device 10 to form the archival image. The metadata can also include but is not limited to any other information determined by controller 32 or stored in any memory in digital image capture device 10 such as information that identifies digital image capture device 10, and/or instructions for rendering or otherwise processing the digital image with which the metadata is associated. The metadata can also comprise an instruction to incorporate a particular message into digital image when presented. Such a message can be a text message to be rendered when the digital image is presented or rendered. The metadata can also include audio signals or text messages if such input options are provided. The metadata can further include digital image data. The metadata can also include any other information entered into digital image capture device 10.

The digital images and optional metadata can be stored in a compressed form. For example where the digital image comprises a sequence of still images, the still images can be stored in a compressed form such as by using the JPEG (Joint Photographic Experts Group) ISO 10918-1 (ITU-T.81) standard. This JPEG compressed image data is stored using the so-called “Exif” image format defined in the Exchangeable Image File Format version 2.2 published by the Japan Electronics and Information Technology Industries Association JEITA CP-3451. Similarly, other compression systems such as the MPEG-4 (Motion Images Export Group) or Apple Quicktime™ standard can be used to store digital image data in a video form. Other image compression and storage forms can be used.

The digital images and metadata can be stored in a memory such as memory 40. Memory 40 can include conventional memory devices including solid state, magnetic, optical or other data storage devices. Memory 40 can be fixed within digital image capture device 10 or it can be removable. In the embodiment of FIG. 1, digital image capture device 10 is shown having a memory card slot 46 that holds a removable memory 48 such as a removable memory card and has a removable memory interface 50 for communicating with removable memory 48. The digital images and metadata can also be stored in a remote memory system 52 that is external to digital image capture device 10 such as a personal computer, computer network, remote server or other imaging system.

In the embodiment shown in FIG. 1 and FIG. 2, digital image capture device 10 has a communication circuit 54 for communicating with the remote memory system. The communication circuit 54 can be for example, an optical, radio frequency or other transducer that converts image and other data into a form that can be conveyed to the remote imaging system by way of an optical signal, radio frequency signal or other form of signal.

Examples of communication circuit 54 include, but are not limited to, circuits and systems that communicate in ways that that conform to wireless communication standards such as the so-called “Wi-Fi” and so-called “Bluetooth” standards established and described at Institute of Electrical and Electronic Engineers standards 802.11a and 802.11b. Alternatively, communication circuit 54 can be adapted to communicate using infrared technology using protocols established by the infrared data association (IrDA). Such protocols include, but are not limited to the serial infrared protocol (SIR) and other protocols developed by the IrDA. Communication circuit 54 can also be used to receive a digital image and other information from a host computer or network (not shown). Controller 32 can also receive information and instructions from signals received by communication circuit 54 including but not limited to, signals from a remote control device (not shown) such as a remote trigger button (not shown) and can operate digital image capture device 10 in accordance with such signals.

Signal processor 26 optionally also uses images signals or the digital images to form evaluation images which have an appearance and/or content that corresponds to captured image data and are adapted for presentation on display 30. This allows users of digital image capture device 10 to observe digital images that are available in digital image capture device 10 for example images that have been captured by image capture system 22, that are otherwise stored in a memory such as memory 40, removable memory 48 or that are received by way of communication circuit 54. Display 30 can comprise, for example, a color liquid crystal display (LCD), organic light emitting display (OLED) also known as an organic electroluminescent display (OELD) or other type of video display. Display 30 can be external as is shown in FIG. 2, or it can be internal for example used in a viewfinder system 38. Alternatively, digital image capture device 10 can have more than one display with, for example, one being external and one internal, or both external such as a stereoscopic display.

Signal processor 26 and controller 32 also cooperate to generate other images such as text, graphics, icons and other information for presentation on display 30 that can allow interactive communication between controller 32 and a user of digital image capture device 10, with display 30 providing information to the user of digital image capture device 10 and the user of digital image capture device 10 using user input system 34 to interactively provide information to digital image capture device 10. Digital image capture device 10 can also have other displays such as a segmented LCD or LED display (not shown) which can also permit signal processor 26 and/or controller 32 to provide information to user 10. This capability is used for a variety of purposes such as establishing modes of operation, entering control settings, user preferences, and providing warnings and instructions to a user of digital image capture device 10. Other systems such as known systems and actuators for generating audio signals, vibrations, haptic feedback and other forms of signals can also be incorporated into digital image capture device 10 for use in providing information, feedback and warnings to the user of digital image capture device 10.

Typically, display 30 has less imaging resolution than image sensor 24. Accordingly, signal processor 26 reduces the resolution of image signal or digital image when forming evaluation images adapted for presentation on display 30. Down sampling and other conventional techniques for reducing the overall imaging resolution can be used. For example, re-sampling techniques such as are described in commonly assigned U.S. Pat. No. 5,164,831, in the name of Kuchta et al., titled: “Electronic Still Camera Providing Multi-Format Storage Of Full And Reduced Resolution Images”. The evaluation images can optionally be stored in a memory such as memory 40. The evaluation images can be adapted to be provided to an optional display driver 28 that can be used to drive display 30. Alternatively, the evaluation images can be converted into signals that can be transmitted by signal processor 26 in a form that directly causes display 30 to present the evaluation images. Where this is done, display driver 28 can be omitted.

Digital image capture device 10 can receive digital images for processing in a variety of ways. For example, digital image capture device 10 can capture digital images using image sensor 24 as described above. Imaging operations that can be used to obtain digital images from image capture system 22 include a capture process and can optionally also include a composition process and a verification process.

During the optional composition process, controller 32 causes signal processor 26 to cooperate with image sensor 24 to capture digital images and present a corresponding evaluation images on display 30. In the embodiment shown in FIG. 1 and FIG. 2, controller 32 enters the image composition phase when shutter trigger button 60 is moved to a half depression position. However, other methods for determining when to enter a composition phase can be used. For example, one of user input system 34, for example, the “select-it” button 66 shown in FIG. 2 can be depressed by a user of digital image capture device 10, and can be interpreted by controller 32 as an instruction to enter the composition phase. The evaluation images presented during composition can help a user to compose the scene for the capture of digital images.

The capture process is executed in response to controller 32 determining that a trigger condition exists. In the embodiment of FIG. 1 and FIG. 2, a trigger signal is generated when shutter trigger button 60 is moved to a full depression condition and controller 32 determines that a trigger condition exists when controller 32 detects the trigger signal. During the capture process, controller 32 sends a capture signal causing signal processor 26 to obtain image signals from image sensor 24 and to process the image signals to form digital image data comprising a digital image. An evaluation image corresponding to the digital image is optionally formed for presentation on display 30 by signal processor 26 based upon the image signal. In one alternative embodiment, signal processor 26 converts each image signal into a digital image and then derives the evaluation image from the digital image.

During the verification phase, the corresponding evaluation image is supplied to display 30 and is presented for a period of time. This permits a user to verify that the digital image has a preferred appearance.

Digital images can also be received by digital image capture device 10 in ways other than image capture. For example digital images can by conveyed to digital image capture device 10 when such images are recorded on a removable memory that is inserted into memory interface 50. Alternatively digital images can be received by way of communication circuit 54. For example, where communication circuit 54 is adapted to communicate by way of a cellular telephone network, communication circuit 54 can be associated with a cellular telephone number or other identifying number that for example another user of the cellular telephone network such as the user of a telephone equipped with a digital camera can use to establish a communication link with imaging device 10 and transmit images which can be received by communication circuit 54. Accordingly, there are a variety of ways in which imaging device 10 can receive images and therefore it is not essential that imaging device 10 have an image capture system so long as other means such as those described above are available for importing images into imaging device 10.

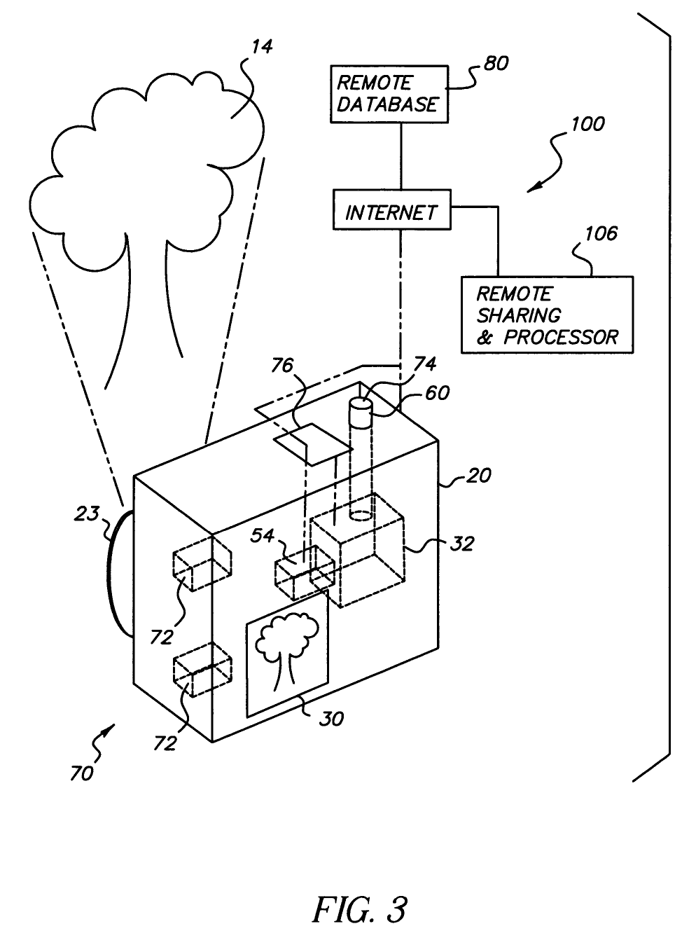

FIG. 3 depicts a perspective view of image capture device 10 of FIGS. 1 and 2 used for capturing an image of a scene 14. As shown in FIG. 1 above, digital image capture device 10 includes a biometric reader 70. Biometric reader 70 is connected to microprocessor 26 and to communication circuit 54. Biometric data read by biometric reader 70 is provided to communication circuit 54 which transmits the biometric data to a remote database 80 that has stored the biometric data therein.

Biometric reader 70 can be a retinal scanner 72 that is adapted to obtain an image of an eye of a user. Biometric reader 70 can also comprise a fingerprint reader 74. If a fingerprint reader 74 is used, fingerprint reader 74 can be located on the shutter trigger button 60. In an alternative embodiment, biometric reader 70 can be a voice print reader 76, which can be used with the retinal scanner 72 or with fingerprint reader 74 or both.

Biometric reader 70 can be adapted to sense one type of biometric data or multiple types and/or can comprise one or more different types of reader. Biometric reader 70 can incorporate portions of use input system 34 or sensors 36, including but not limited to, a microphone, touchpad, eye monitor, or other such sensors as may be useful.

During a set-up function of digital image capture device 10, all authorized users, such as a set of employees of a design firm, provide at least one piece of biometric data for storage in remote database 80. The biometric data can be an original fingerprint, a group of fingerprints, a voiceprint, one or more retinal scans, or other biometric data. Along with the biometric data, names and other identifying codes—such as facial images, social security codes, personal identification codes and an image of a user's choice which operates like a signature—can be stored in remote database 80 as biometric user identification data. User preferences that define operating modes or other customizable aspect of the digital image capture device 10 can also be defined and stored in association with the biometric data for a user. The stored biometric user identification data is then associated with a set of authorized activities that identifies all actions that a user, providing such biometric user identification data, is allowed to perform using image capture device 10. Database 80 is remote to digital image capture device 10, as depicted in FIG. 3. Optionally, as shown in FIG. 3, communication circuit 54 can communicate with database 80 by way of the Internet.

When a user desires to use image capture device 10, biometric reader 70 obtains biometric data such as a fingerprint, a voiceprint, a retinal scan, or combinations thereof of the prospective user. Communication circuit 54 communicates the biometric data wirelessly to database 80 to compare the newly scanned data to the previously stored biometric data. If there is a match, a set of authorized actions can be associated with that user and an authorization signal can be wirelessly transmitted to image capture device 20. Communication circuit 54 and controller 32 cooperate to receive the authorization signal to determine the set of authorized actions from the authorization signal and enables the user to perform only the actions in the set of actions. Where the set of actions includes image capture, captured images can be stored in memory of the digital image capture device 10 or transmitted simultaneously, or subsequently, via communication circuit 54 to database 80 or some other database or storage device as desired.

For example, when controller 32 detects a user request that an image be taken, the fingerprint of the user can be obtained to compare to the authorized users in database 80. If an appropriate authorization signal is received, image capture device 10 enables, thereby permitting the authorized user to use image capture device 10. The actual name of the user or other identifying data can be provided by database 80 in the authorization signal and such identifying data can be stored in association with the captured image. If the user is not authorized, controller 32 does not enable this function and the unauthorized user is prohibited from capturing the image. The user can also be prohibited from modifying, transmitting, and/or receiving images.

In an alternative embodiment, digital image capture device 10 can always be enabled to allow selected actions to occur, but locked from particular actions, such as actions that irreversibly alter or delete captured images pending receipt of authorization upon receipt of appropriate biometric data. In such an embodiment, an image capture device 10 can be set to allow the image to be captured without receipt of authorization. However, appropriate biometric based authorization would need to be obtained later so that a captured image could be unlocked, viewed, edited, or otherwise used. This can be useful, for example, where a medical doctor is wearing gloves or an unauthorized orderly attempts to capture an image, image capture device 10 allows an image to be captured but saved in a temporary manner, or saved but locked.

The embodied method and image capture device 10 can be used for commercial use by professional photographers, for consumer user, or by the casual user.

FIG. 4 depicts an embodiment wherein digital image capture device 10 comprises a body 20 in a wearable shape, such as eyeglasses, sunglasses, night vision goggles, or other similar types of eyewear or bodywear. Such a wearable embodiment of image capture device 10 can have multiple biometric readers 70 including, but not limited to, a retinal scan type biometric reader 72. If digital image capture device 10 of this type is used for military eyeglasses or police glasses, the use of a verifying biometric reader 70 that reads two different biometric data points can be used so that a fallen soldier's fingerprint alone cannot be used to enable image capture device 10. FIG. 4 shows the wearable digital capture device 10 can optionally generate broadcast signal 95 that relays information, such as an image and associated time and place data to a remote database 80 or elsewhere.

A controlled distribution method for a digital image capture device 10 entails obtaining biometric data from at least one user, such as a news reporter. The method continues by entering the biometric data of that user, such as the news reporter, into a database that is preferably remote to the location of the news reporter. For example, the news reporter is on location capturing images and the database is at a local, regional, national or international studio.

Next, a digital image capture device 10 with biometric reader 70 is assigned to the user, such as a digital camera to the news reporter. The digital camera is designed with at least one biometric reader to read the user's biometric data. In the example, the reporter's biometric data is read as image capture device 10 is held and transmitted to the remote database 80 via a communication circuit 54. For example, the news reporter can have an eye scan by a retinal eye scanner 72 in viewfinder 38 of image capture device 10 as the biometric data. A fingerprint reader 74 on the handle of image capture device 10 can also provide another biometric reader 70. Database 80 associates biometric data with a set of authorized activities. Database 80 can also use the biometric data to track the location of image capture device 10 for the true owner, in order to deter against theft and find the location of reporters, or if the reporter or user is in dangerous locations, such as a war zone.

Next, remote database 80 transmits wireless signal having an authorization from which controller 32 can determine a set of actions that the user is authorized to perform. The images are captured, and transmitted for immediate broadcast as an adjunct to a video story or other story. Optionally, controller 32 can embed or otherwise associate biometric data of the user or other identifying data determined based upon the biometric data into the digital file of the image or directly onto the image. The biometric data associated to the image is very helpful when a voice transmission cannot work well due to high ambient noise levels. Digital image capture device 10 can be remotely enabled to perform any of a set of actions including, but not limited to, image capture, image presentations deleting an image, capturing an image, receiving an image, editing an image, prepare for capturing an image, printing an image, sharing an image, or performing no actions. The images can be broadcast to another device based on the biometric data. The voice of the reporter or photographer can also be captured and added as metadata to the picture. This voice metadata can be translated into digital form, optionally locked by encrypting the voice so that a receiver can translate the voice metadata back into a clear, human voice.

In the embodiment of FIG. 4, a distribution system 100 is provided. Distribution system 100 can organize images taken remotely based on the biometric data associated with the images. Distribution system 100 can include an embodiment of database 80 that enables various users of digital images to be grouped based on their biometric data. Digital images optionally can be sorted either before transmitting the images or when the images are received. The images can be sorted by a defined set of user addresses, by digital content type, by individual user preferences, by digital image characteristics, and combinations thereof. The images can be organized by photographer names, such as alphabetical names of the photographer, or by biometric linked data, such as the retinal pattern of the photographer. The images can also be organized by content of the images, such as by sorting the images into groups of close relatives, or friends, by locations of where the images were taken, or using any number of other sorting criterion.

In the embodiment of FIG. 4, distribution system 100 includes a communication network 104 such as a wired or wireless telecommunication network, the Internet and the like, and a remote processing and sharing system 106 that can process images from image capture device 10. Remote processing and sharing system 106 can be a computer, such as a worldwide web server, or any other digital image processor that can use distribution system 100 to share images.

As is shown in FIG. 1, digital image capture device 10 can incorporate an additional image capture system 22 such as a second electronic image capture system or such as a film or other photochemical based image capture system.

In the case of attaching the biometric data to an image captured on film the metadata depicting the biometric data can be recorded on the film as a latent image, such as in a form visible or stegonographic form that can be detected at the photofinishing stage. Alternatively, instructions can be given to a photofinishing machine to imbed the biometric data on the printed image or on the back of a photograph made from a film image. Alternatively, the photos can become “smart photos”, wherein the photos contain a chip that contains the biometric data. The “smart photos” provide an advantageous manner for tracking significant and important original photos. A fingerprint or voiceprint can be metadata printed on the back of the photo or embedded into the digital file of the image. In still another embodiment, a voiceprint can be incorporated into the digital file of the image for identification purposes.

In another embodiment of distribution system 100, the recorded images can be valued based on the biometric data. For examples, images from a known photographer are tagged as worth more than photos of an unknown photographer.

Another embodiment of distribution system 100 contemplates the step of broadcasting the images based on the biometric data to another device such as for real time viewing.

The invention has been described in detail with particular reference to certain preferred embodiments thereof, but it will be understood that variations and modifications can be effected within the spirit and scope of the invention.

### PARTS LIST

10. digital image capture device
14. object of interest
16. transmitter/receiver
20. housing or body
22. image capture system
23. lens or lens system
24. image sensor
26. processor
28. optional display driver
30. screen or display
32. controller
34. user input system
36. sensors
38. viewfinder system
40. memory
46. memory card slot
48. removable memory
50. removable memory interface
52. remote memory system
54. communication circuit
60. shutter trigger button
62. wide-angle zoom button
64. tele zoom button
66. select-it button
67. mode selector button
68. joystick
70. biometric reader
72. retinal eye scanner
74. fingerprint reader
76. voice print reader
80. remote database
95. broadcast signal
100. distribution system
104. communication network
106. processing and sharing system

1. A digital image capture device comprising:
a housing (20);
a digital image capture system (22);
a biometric reader (70) adapted to sense biometric data of a user;
a wireless communication circuit (54) adapted to transmit wireless signals to a remote database and to receive authorization signals from the remote database;
a processor (26) adapted to control and enable operation of the digital image capture system (22), the wireless communication circuit (54) and the biometric reader (70), wherein the processor (26): is adapted to cause biometric data to be read from a user, and wirelessly transmitted to a remote database so that the remote database can compare the sensed biometric data to stored biometric data and will transmit an authorization signal when the sensed biometric data corresponds to stored biometric data, said processor further being adapted to determine a set of authorized actions for a user of the digital image capture device based upon an authorization signal transmitted by the remote database; with said processor further being adapted to execute actions as requested by the user when the requested actions are within the set of authorized actions.

2. The digital image capture device of claim 1, wherein the wireless communication circuit connects to the remote database at least in part via the Internet or a closed wireless system.

3. The digital image capture device of claim 1, wherein the biometric reader is a fingerprint reader integral with a shutter trigger button on the digital image capture device.

4. The digital image capture device of claim 1, wherein the biometric data comprises a first biometric scan for identification of the user and a second biometric scan for verification of the user.

5. The digital image capture device of claim 1, wherein the device is a digital camera, a digital phone, a wearable capture device with digital image camera, a personal digital assistant, or combinations thereof or other digital capture devices or a stereoscopic capture device.

6. The digital image capture device of claim 1, wherein the biometric reader is a retinal reader, a voice print reader, a fingerprint reader, or combinations thereof.

7. The digital image capture device of claim 1, wherein the biometric reader is incorporated with a display.

8. The digital image capture device of claim 1, wherein the processor further associates biometric data with the image and wirelessly transmits the biometric data with the image.

9. The digital image capture device of claim 1, wherein the set of authorized actions include at least one of capturing image, presenting a captured image, deleting an image, distributing an image, receiving an image, editing an image, preparing for capturing an image, printing an image, sharing an image, and performing no actions.

10. The digital image capture device of claim 1, wherein said database stores user preference information and transmits user preference information with the authorization signal.

11. A method for operating a digital image capture device comprising the steps of:
obtaining biometric data from at least one user, entering the biometric data in a database;
reading biometric data from the user of the device;
transmitting the biometric data to the database wirelessly;
determining a set of authorized actions based upon the biometric data, and
wirelessly enabling the device to perform the set of authorized actions.

12. The method of claim 11, further comprising the steps of recording the biometric data of the user of the device with each recorded image and transmitting the image and the biometric data to the remote database.

13. The method of claim 12, further comprising the step of organizing images remotely based on the biometric data linked to the images.

14. The method of claim 11, further comprising the step of valuing the recorded images based on the biometric data.

15. The method of claim 11, further comprising the step of broadcasting the image data to another device based on the biometric data.

16. The method of claim 11, further comprising the step of transmitting the images based on parameters, wherein the parameters comprise:
a defined set of users addresses;
a digital content type;
a biometric data for an individual user; and
combinations thereof.

17. The method of claim 12, further comprising the step of setting receiving parameters for the digital image capture device, wherein the receiving parameters comprise at least one of:
user preferences;
digital image receiver preferences;
digital content type;
characteristics of a digital image; and
combinations thereof.

18. The method of claim 11, wherein the digital image capture device is adapted to receive an authorization to enable a set of activities from a remote device with the remote device determining which activities are authorized.

19. The method of claim 12, further comprising the step of broadcasting the images based on the biometric data to another device.

20. The method of claim 11, further comprising the steps of capturing a film image and associating metadata with the film image, said associated metadata being based upon the read biometric data.

21. An image capture device comprising:
an image capture means for capturing an image of a scene;
a biometric reading means for sensing a biometric characteristic of a user of the image capture device;
a wireless communication system for transmitting and receiving wireless data signals;
an authorization means for causing the sensed biometric reading means to sense a biometric characteristic of a user, to convert the sensed biometric characteristic into sensed biometric data, and to cause the wireless communication means to transmit a wireless signal containing said biometric data to a remote database, said remote database sending an authorization signal when the sensed biometric data is similar to stored biometric data of an authorized user, with said authorization means further being adapted to determine a set of authorized actions based upon the authorization signal; and
an action execution means for enabling the image capture device to execute the authorized actions.
